(19) United States
(12) Patent Application Publication
(10) Pub. No.: US 2006/0065131 A1
(43) Pub. Date: Mar. 30, 2006

(54) Drip tray with cover

(76) Inventor: Shea Taylor, Clairmont (CA)

Correspondence Address: DONALD V. TOMKINS;C/O TOMKINS LAW OFFICE, 740, 10150 - 100 STREET, EDMONTON, AB, T5J 0P6, CA

(21) Appl. No.: 11/231,880

(22) Filed: Sep. 22, 2005

(30) Foreign Application Priority Data
Sep. 27, 2004 (CA) 2,483,315

(51) Int. Cl. A47J 27/00

(52) U.S. Cl. 99/446

(57) ABSTRACT

A transportable drip tray and cover assembly provides liquid-tight retention of collected liquids. The tray has a bottom plate with upstanding walls forming a chamber for receiving liquids. A continuous shoulder is formed in the top of the walls, and the cover is fashioned with a continuous, downwardly-extending lip that aligns with the shoulder, and a resilient sealing material is positioned on the shoulder. When the cover is mounted on the tray, the lip will press into the sealing material to create a liquid-tight seal. When the tray needs to be emptied, the cover can be closed onto the tray, and the assembly can be transported to a disposal site by any convenient means without liquid splashing or leaking from the tray. The assembly may include latches to secure the cover to the tray and to further compress the resilient sealing material. The tray or cover may include an outlet to facilitate drainage from the chamber without removing the cover.

### FIELD OF THE INVENTION

The present invention relates in general to receptacles for receiving liquids, and in particular relates to drip trays having liquid-tight covers or lids.

### BACKGROUND OF THE INVENTION

Drip trays are commonly used in many industrial applications, such as in the field of oil and gas exploration and production, and also for non-industrial uses. For example, a drip tray may be placed under a motor, transmission, pump, or other piece of equipment during servicing or removal to catch liquids such as hydraulic fluid or lubricating oil. In some cases a drip tray may be placed under a piece of equipment while it is in operation, as a precaution to catch any liquids that might leak from the equipment due to mechanical breakdown or deterioration of gaskets and other sealing means. Drip trays may be fabricated in a variety of configurations, but they typically feature a bottom section with side walls defining an open pan, and may or may not have a cover. For industrial applications in particular, where a drip tray is being used in association with a large piece of equipment, it will generally be desirable to use a fairly large drip tray.

In typical uses, the liquid that a drip tray is employed to receive is a potential environmental hazard, or for some other reason it is necessary or desirable to ensure that the liquid does not leak or splash or spill from the tray, particularly when the tray is being transported to a disposal site or is being poured from the tray at the disposal site. At the same time, it is generally desirable for the drip tray to be relatively shallow in order to facilitate use underneath a variety of types of equipment from which liquids may leak or overflow. However, a shallow drip tray, with comparatively short or low perimeter walls and an open top, is difficult to transport to a disposal site without splashing or spilling, because the liquid in the drip tray will be highly prone to sloshing back and forth and splashing over the walls. Accordingly, it is desirable for the drip tray to have means for preventing or minimizing splashing and spillage of liquid from the tray during transport. Balancing against the desirability for a drip tray to have a large open area and means to prevent spillage is the practical necessity or desirability for the drip tray apparatus to be of such size and weight that it can be positioned and transported without undue difficulty by manual or mechanical means whether empty or substantially full of liquid.

The importance of these considerations can be illustrated by a particular example of drip tray use in the field of oil and gas exploration and production. Mobile well testing equipment commonly travels to well sites to conduct on-site testing of fluids being produced from the wells. These fluids may include liquid and gaseous hydrocarbons (i.e., crude oil and natural gas produced from a subsurface formation), drilling fluid (commonly called “drilling mud”), “frac oil” (a liquid introduced into the well to induce or promote fracture of subsurface formations to enhance flow of hydrocarbons into the well), and formation water. These fluids commonly will contain sand or rock particles. The well testing procedure typically involves running a testing line of nominal 2-inch or 3-inch (50 to 75 mm) pipe across the ground surface (typically raised on blocks) from the wellhead to the mobile unit, which is commonly required by regulation to be 40 feet (12 meters) or more away from the wellhead. The testing line is connected to a wellhead pipe nipple so that well fluids will flow into the testing line from the production tubing of the well, or in some instances from the annulus between the production tubing and the wellbore or casing. The well fluids are then pumped into a tank on the mobile unit, so that samples can be extracted from the tank for testing.

In order to do this testing with a mobile unit, the testing line is made up of several smaller sections (typically 10 to 15 feet or 3.0 to 4.5 meters long) that are easy to transport on a truck, plus a variety of associated pipe fittings. When the testing procedure is complete, the testing line is typically flooded with liquid of some sort, and this liquid will drain out when the testing line is disassembled for transport to a different well site. This liquid generally cannot be allowed to contaminate the ground surface, so an open-top drip tray is positioned under each joint between pipe sections and/or pipe fittings in the testing line. Each drip tray is sized to receive an amount of liquid greater than the volume of the pipe components that will drain into it; rectangular trays measuring about 2 feet by 5 feet (0.6 meters by 1.5 meters) are commonly used for this purpose. The pipe components rest on the tray edges so that when each pipe joint is eventually broken open, the liquid in the pipe will flow into the trays.

The problem then becomes moving these liquid-laden, open-top trays to a disposal facility without spilling any of the liquid. In common oilfield practice, the trays are manually transported by a couple of workers to a disposal tank, which is often elevated above ground. The workers then need to pour the liquid out of the trays into the tanks, which often entails raising the trays up to open top of the tank. In some cases, a hoisting means is used to raise the trays up to the top of the tank, but whether the trays are raised manually or with mechanical assistance, it is difficult to carry out this procedure without risk of spillage or splashing from the trays.

Drip trays are used in a similar way in other oilfield applications, such as for draining piping used for circulating water through a well (such as for sand removal or other common purposes) during well servicing operations by a service rig. Drip trays are used where hoses from vacuum trucks (or “vac trucks”) are connected to a piece of equipment, such as for emptying a tank. In general, drip trays are typically used in oil and gas operations where there are piping connections or hose connections for any purpose, and where there is a risk that harmful or otherwise undesirable liquids could drip or spill onto the ground when the pipe or hose is disconnected.

The prior art discloses a number of drip trays directed to one or more of the objectives and desirable features discussed above.

U.S. Pat. No. 6,446,907 (Wilson et al.) describes a fluid-tight drip pan specifically intended to catch drips from the engine or transmission compartment of a helicopter. While this drip pan may be effective for this intended use, it is not readily adaptable for non-analogous uses, since it is specifically adapted to be securely mounted to the engine or transmission compartment.

U.S. Pat. No. 5,775,869 (Bishop) discloses a transportable spill pan with hinged covers. This apparatus is specially adapted for use under rail cars, and thus has the disadvantage of not being suitable for general use in a range of different applications. It has further disadvantages in that it is must be moved using equipment such as a forklift, and the covers do not provide a liquid-tight seal to prevent leakage during transport.

U.S. Pat. No. 6,102,086 (Holtby) describes a drip tray that unlike the Wilson and Bishop trays can be readily used in many different situations, such as to catch oil drips when the oil filter on a motor is being changed, or to catch drilling fluids dripping from drill pipe withdrawn (or “tripped”) from a wellbore. The Holtby drip tray is actually an assembly of individual shallow, open-top trays interconnected so as to enlarge the total coverage area. Jaw-like locking members may be used to interconnect the trays. To empty the drip tray assembly, the locking members are removed and the individual trays are emptied separately. The Holtby tray apparatus thus can be effective to facilitate catching drips over a large area while keeping the components of the apparatus (i.e., the individual trays) small enough that manual workers can lift them without great difficulty whether empty or full. However, the Holtby apparatus does not address the problem of splashing and spillage during transport to a disposal site, because the individual trays of the apparatus are always open-topped.

One possible way to address the splashing and spillage problem would be for the drip tray to have a perimeter partial cover extending inward from the tops of the walls of the tray, leaving a central opening through which liquids could drip into the tray. The perimeter partial cover would act as a barrier to liquid tending to splash the walls while the tray is being transported. However, transport of the tray would still require a considerable degree of care to prevent liquid splashing and spillage out of the central opening. A further disadvantage of this concept is that the perimeter partial cover would reduce the open area available to catch drips to area, compared to the total tray area.

For the foregoing reasons, there remains a need for a drip tray that has an optimally large open area for receiving liquids, while at the same time providing means for preventing liquids retained in the tray from leaking or splashing out of the tray while the tray is being transported to a liquid disposal facility. The present invention is directed to these needs and objects.

### BRIEF SUMMARY OF THE INVENTION

The foregoing needs and objects are addressed in the present invention by providing a drip tray and cover that provide a continuous liquid-tight seal around the perimeter of the tray when the cover is in place on the tray. The tray has a bottom plate with upstanding walls forming a chamber for receiving liquids. The tray will preferably be rectilinear, but could take other shapes as well, including polygonal (e.g., hexagonal or octagonal) and curvilinear (e.g., circular or elliptical). A continuous shoulder is formed in the top of the walls, and the cover is fashioned with a continuous, downwardly-extending lip that aligns with the shoulder in the walls. A resilient sealing material, such as a rubber or foam gasket (or other suitable material known in the art), is positioned on the shoulder. When the cover is positioned on the tray, the lip presses into the resilient sealing material to create a liquid-tight seal between the tray and cover. Therefore, when the tray needs to be emptied, the cover can be closed onto the tray, and the tray/cover assembly can be transported to a disposal site by any convenient means without concern that the liquid contained in the tray will splash or leak from the tray.

Accordingly, in one aspect the present invention is a drip tray apparatus comprising:
(a) a tray having a bottom plate and a plurality of walls extending upward from the bottom plate so as to define a chamber having an open top; and
(b) a cover having a top plate with an upper surface and a lower surface, said cover being adapted to engage the upper edges of the walls so as to create a substantially liquid-tight seal between the cover and the walls when the cover is in a closed position on the tray.
   In the preferred embodiment, the upper edges of the tray walls are configured to define a continuous primary shoulder, continuous resilient sealing means is positioned on the primary shoulder, and the cover is configured to define a continuous, downwardly-extending primary lip, said primary lip being matingly engageable with the primary sealing means, such that when the cover is placed over the tray with the primary lip aligned with the primary sealing means, application of downward force on the cover will urge the primary lip into mating and substantially liquid-tight engagement with the primary sealing means.

The primary shoulder may be adjacent to and contiguous with either the inner or outer surfaces of the tray walls. Alternatively, the tops of the walls may be formed with a continuous central groove, with the bottom of the groove forming the primary shoulder.

The cover may be completely separable from the tray, thus allowing for several trays to be deployed adjacent to each other so as to increase the area over which dripping liquids may be captured. Alternatively, the cover may be connected to the tray in a fashion (such as with hinges or similar means) allowing the cover to be moved between an open position and a closed position.

In the preferred embodiment, the drip tray apparatus includes latching means for releasably securing the cover onto the tray when the cover is in the closed position. Preferably, the latching means will be configured such that actuation of the latching means will induce compressing force between the cover and the tray, with the result that the downwardly-extending lip of the cover is urged, or further urged, into sealing contact with the resilient sealing material. The latching means may be provided by way of one or more latching devices having mating male and female components. Preferably a number of latching devices will be deployed at selected spacing around the perimeter of the tray to ensure that the cover will remain sealingly secured to the tray should one of the devices fail or be inadvertently disengaged.

In an alternative embodiment, further assurance of liquid-tightness may be provided by way of a secondary resilient sealing means adjacent to the primary resilient sealing means.

The drip tray preferably will have two or more lifting handles to facilitate manual transport of the tray.

The drip tray may be emptied by removing the cover (or, in the case of a hinged cover, opening the cover) and pouring the liquid-directly out of the tray chamber over the walls. In alternative embodiments, however, the tray is provided with an outlet through which the liquid can be drained from the tray chamber without needing to remove or open the cover. In such alternative embodiments, the cover may be provided with vent means facilitate drainage through the outlet, by preventing the development of negative air pressure inside the tray/cover assembly due to the flow of liquid through the outlet.

The drip tray and cover may be made using any suitable materials of construction, which could include sheet steel or aluminum. In the preferred embodiment, however, both the tray and cover are made from a rigid, durable plastic material providing the tray and cover with good structural strength without being unmanageably heavy. The materials used for the tray and cover, whether plastic or other material, will preferably have good impact resistance to minimize the risk of fracture or deformation damage in the event of the tray and/or cover being inadvertently dropped or otherwise damaged. As well, the materials will preferably have good resistance to extreme cold temperatures, to ensure that the tray/cover assembly can be reliably used in winter in cold climates such as northern Canada, without special concern regarding brittle fracture.

### BRIEF DESCRIPTION OF THE DRAWINGS

Embodiments of the invention will now be described with reference to the accompanying figures, in which numerical references denote like parts, and in which:

FIG. 1 is a plan view of a drip tray in accordance with a first embodiment of the present invention.

FIG. 2 is a plan view of a drip tray cover in accordance with a first embodiment of the invention.

FIG. 3 is a side view of the drip tray and drip tray cover shown in FIGS. 1 and 2 respectively, with the cover in position for being lowered into position on the drip tray.

FIG. 4 is a partial cross-section through the drip tray and cover on line A-A in FIG. 3, showing the sealed joint between the tray and cover in accordance with a first embodiment of the invention.

FIG. 5 is a partial cross-section through the drip tray and cover on line A-A in FIG. 3, showing the sealed joint between the tray and cover in accordance with a second embodiment of the invention.

FIG. 6 is a partial cross-section through the drip tray and cover on line A-A in FIG. 3, showing the sealed joint between the tray and cover in accordance with a third embodiment of the invention.

FIG. 7 is a partial cross-section through the joint formed between the drip tray and cover of a fourth embodiment of the invention.

FIG. 8 is a plan view illustrating the drip tray of the invention being used to capture liquids from a system of jointed horizontal pipes.

### DETAILED DESCRIPTION OF THE PREFERRED EMBODIMENT

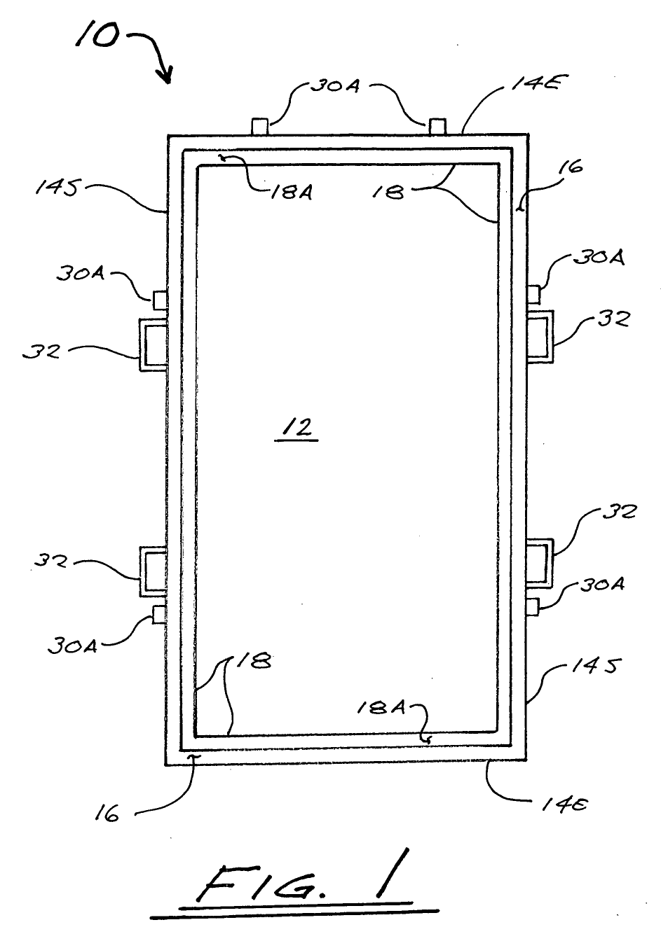

Referring to FIGS. 1, 2, and 3, the present invention includes a drip tray 10, plus a drip tray cover 20 adapted to be matingly engageable with the drip tray 10. The drip tray 10 has a bottom plate 12 and walls 14 extending upward from the bottom plate 12 to form an open-topped, liquid-tight tray chamber 15 into which liquids can be received. In the embodiments illustrated in the Figures, drip tray 10 has opposing side walls 14S and opposing end walls 14E defining a drip tray that is rectangular in plan, and further descriptions herein will be with reference to a drip tray 10 and corresponding cover 20 of such rectangular configuration. However, this shape is not essential to the invention; the drip tray 10 may take any of various shapes, including polygonal or curvilinear, or a combination of polygonal and curvilinear, without departing from the scope of the present invention.

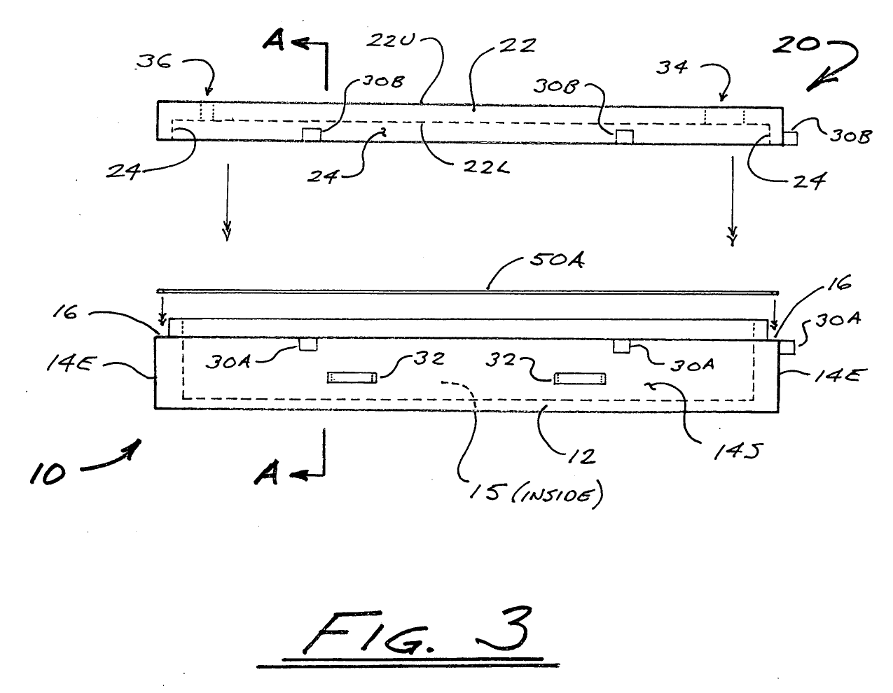

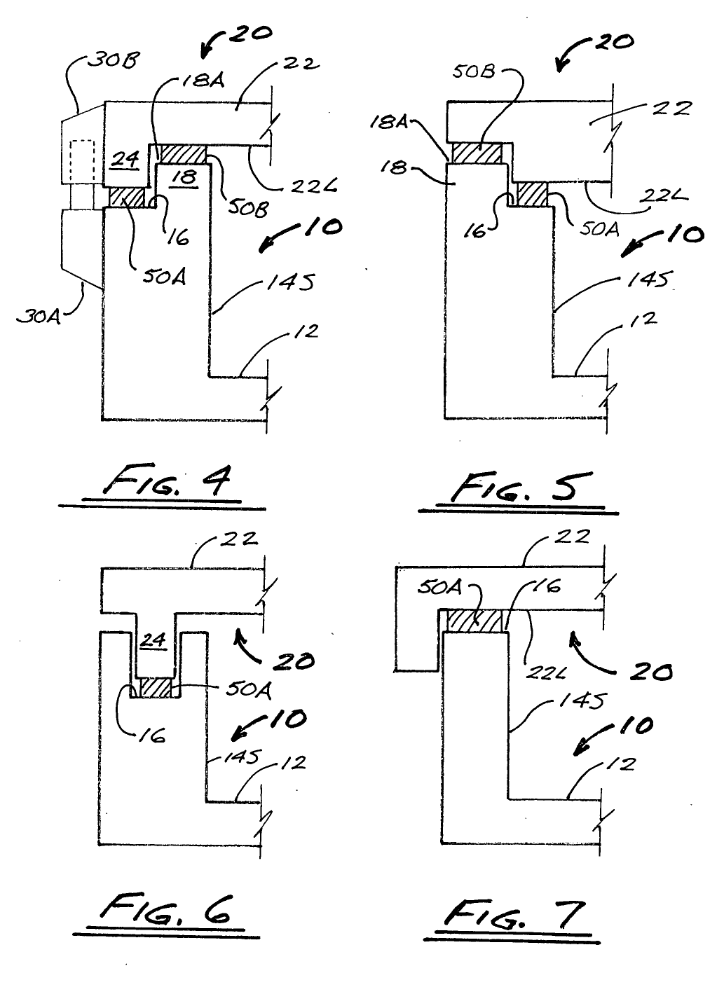

The uppermost portion of the side walls 14S and end walls 14E is notched to define a continuous primary shoulder surface 16. In the embodiment shown in FIGS. 1, 2, and 3, the primary shoulder 16 is adjacent to and contiguous with the exterior faces of the side walls 14S and end walls 14E, as illustrated in greater detail in FIG. 4. In this embodiment, the notching of the side walls 14S and end walls 14E creates a continuous curb 18 adjacent to the interior faces of the side walls 14S and end walls 14E. In the alternative embodiment shown in FIG. 5, however, the notch is adjacent to the interior faces of the side walls 14S and end walls 14E, such that the primary shoulder 16 is adjacent to and contiguous with said interior faces, and the continuous curb 18 is adjacent to the exterior faces of the side walls 14S and end walls 14E. In the further alternative embodiment shown in FIG. 6, a notch or groove 17 is formed within the width of the side walls 14S and end walls 14E, such that the primary shoulder 16 is located at the bottom of the groove 17.

The drip tray cover 20 has a top plate 22 having an upper surface 22U and a lower surface 22L. Extending downward from the lower surface 22L is a continuous primary lip 24 configured to align with the primary shoulder 16 of drip tray 10. A continuous primary resilient seal 50A is disposed between the primary lip 24 and the primary shoulder 16 such that when the cover 20 is lowered onto the drip tray 10, the primary seal 50A will be sandwiched between the primary lip 24 and the primary shoulder 16, thus effecting a seal between the drip tray 10 and the cover 20, so as to deter or prevent leakage of liquid from the tray chamber 15.

The primary seal 50A may be made of rubber, neoprene, plastic foam, or other material suitable for creating a liquid seal. The primary seal 50A may be bonded to either the primary shoulder 16 or the primary lip 24; alternatively, the primary seal 50A may be disposed between the primary shoulder 16 and the primary lip 24 (such as by being laid upon the primary shoulder 16) without use of a bonding agent.

Although a satisfactory seal between the drip tray 10 and the drip tray cover 20 can be achieved using the joint detail shown in FIG. 6, the joint details shown in FIGS. 4 and 5 provide a particular advantage in that debris accumulating on primary shoulder 16 and/or the primary seal 50A would be somewhat more easily removed than debris collecting in the groove 17 of the embodiment in FIG. 6.

The effectiveness of the liquid seal between the drip tray 10 and the cover 20 may be enhanced by providing means for maintaining the primary lip 24 and the primary shoulder 16 in close contact with the primary seal 50A, preferably under sufficient pressure to compress the primary seal 50A to at least a minimal degree. This may be accomplished to a beneficial extent by sizing the primary lip 24 so that it will have a friction fit with the curb 18 of the drip tray 10.

In the preferred embodiment, the drip tray 10 and cover 20 are provided with latching means to provide further assurance that the cover 20 will not become accidentally or inadvertently separated from the drip tray 10. Even more preferably, the latching means will be adapted so as to induce a force tending to clamp the drip tray 10 and the cover 20 together (or further together), and thus in turn increasing the force or pressure with which the primary seal 50A is compressed between the primary lip 24 and the primary shoulder 16, and further enhancing the effectiveness of the seal as a result.

It will be readily apparent to persons skilled in the art that various known types of latching means may be used to perform the desired functions described above. In the Figures, the latching means are conceptually shown as a plurality of two-component latching devices 30 spaced around the joint between the drip tray cover 20 and the drip tray 10. More specifically, each latching device 30 is schematically shown as having a male component 30A that is releasably and lockingly engageable with a female component 30B, with the male components 30A and female components 30B being mounted to the drip tray cover 20 and the drip tray 10 respectively, or vice versa. Preferably the male components 30A and female components 30B are mounted such that some amount of pressure must be applied to the cover 20, when it is being mounted onto the drip tray 10, in order to bring the male components 30A and female components 30B into mating engagement. This pressure is absorbed by compressive deformation of the primary seal 50A disposed between the primary lip 24 and the primary shoulder 16, which in turn enhances the effectiveness of the liquid seal along the joint.

In preferred embodiments of the present invention, the effectiveness of the liquid seal between the drip tray 10 and the drip tray cover 20 is further enhanced by providing a secondary resilient seal, similar to the primary resilient seal 50A described above. In the embodiments shown in FIGS. 4 and 5, the upper surface 18A of curb 18 serves as a secondary shoulder on which a secondary resilient seal 50B may be positioned. When the drip tray cover 20 positioned on the drip tray 10, the secondary seal 50B will be compressed between the secondary shoulder 18A and the lower surface 22L of the top plate 22 of the drip tray cover 20, thus providing a second line of defence against leakage of liquid from the tray chamber 15.

In alternative embodiments, the present invention may be provided with only the secondary resilient seal 50B, as that term is used herein. In other words, the invention may be practised with a resilient seal on positioned on top of the curb 18 and no resilient seal on the shoulder 16 formed by the notch in the side walls 14S and end walls 14E, without departing from the concept and principles of the invention. What is essential is that there be at least one continuous resilient seal disposed between the drip tray cover 20 and the drip tray 10, and the terminology that may be used to designate that resilient seal and the surfaces of the drip tray 10 and drip tray cover 20 with which it comes into contact are a matter of preference.

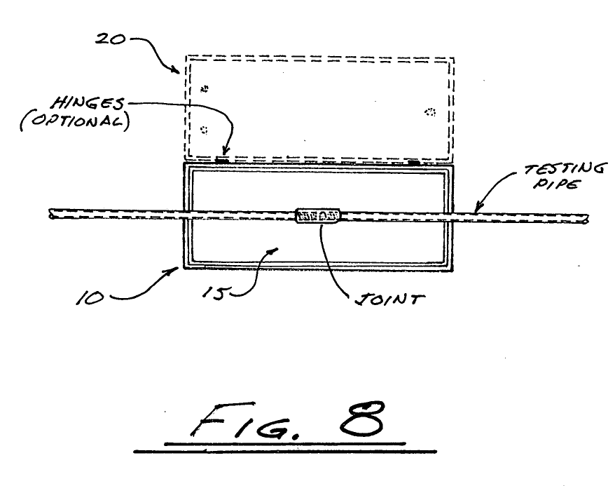

In accordance with this understanding, it will be appreciated that there may be alternative embodiments of the invention in which the side walls 14S and end walls 14E are not notched, and therefore do not define a curb in the sense discussed previously herein. In such embodiments, an example of which is illustrated in FIG. 7, the top surfaces of the side walls 14S and end walls 14E serve as the “primary shoulder” on which the primary resilient seal 50A is disposed. In this embodiment, the drip tray cover 20 does not have a downwardly-extending lip that engages the primary seal 50A; instead, the primary seal 50A is compressed between the top surfaces of the side walls 14S and end walls 14E, and the lower surface 22L of the top plate 22 of the drip tray cover 20.

In the preferred embodiment, the drip tray 10 is provided with a two or more handles 32 to facilitate manual transport of the drip tray 10 both when empty and when containing liquids. In the Figures, two handles 32 are shown on each side of the drip tray 10, but the number and location of the handles 32 will be a matter of preference.

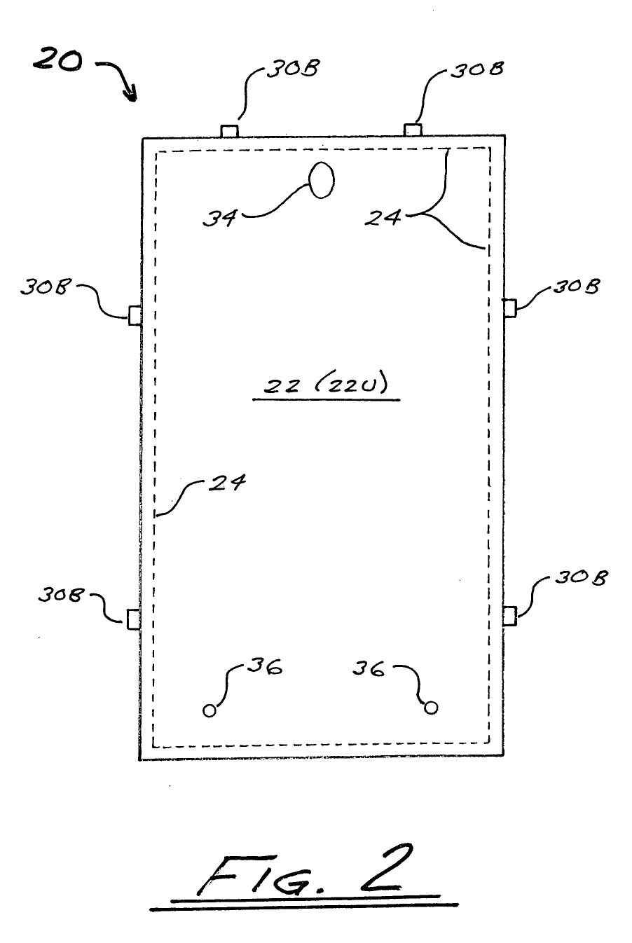

In preferred embodiments, the top plate 22 of the drip tray cover 20 is provided with a drainage port 34 through which liquid may be poured out of the drip tray 10 while the cover 20 is still in place on the drip tray 10. The drainage port 34 will typically be near one edge of the cover 20 although this is not essential. In alternative embodiments, the drainage port 34 may be adapted to receive a spout or vacuum hose connection or other means to facilitate emptying of liquids from the drip tray 10. In other alternative embodiments, the drainage port 34 could be provided in one of the side walls 14S or end walls 14E of the drip tray 10, with suitable means for closing off the drainage port 34 until it is desired to drain liquids from the drip tray 10. To facilitate drainage of liquid through the drainage port 34, the drip tray cover 20 will preferably have one or more vacuum relief vents, as conceptually indicated by reference numeral 36 in FIG. 2.

The drip tray cover 20 may be completely separate from the drip tray 10. In alternative embodiments (not shown), the drip tray cover 20 may be hingingly attached to the drip tray 10 along one of the side walls 14S, or along one of the end walls 14E if desired.

The operation and use of the present invention may be easily understood. The drip tray 10 is positioned under a potential source of dripping or leaking liquid, with the drip tray cover 20 removed (or in the open position if hinged to the drip tray 10). This is illustrated by way of example in FIG. 8, which shows the drip tray 10 positioned under a pipe joint in a testing line for use in well testing procedures as previously described. When liquid accumulates in the tray chamber 15 (such as when the pipe joint in FIG. 7 is broken out and liquid in the testing line empties into the drip tray 10), the cover 20 is positioned on the drip tray 10 (or, in hinged variants, closed onto the drip tray 10) as previously described herein. The liquid is thus retained in an enclosed and substantially liquid-tight drip tray assembly which can be conveniently transported, manually or perhaps with the assistance of mechanical hoisting equipment, to a disposal site with little or no risk of spillage in transit. The drip tray cover 20 may be removed at the disposal site to facilitate quick emptying of the drip tray 10. In embodiments provided with a drainage port 34, the drip tray 10 may optionally be emptied through the drainage port 34 so as to further reduce the risk of inadvertent spillage from the drip tray 10 during the tray emptying operation.

It will be readily appreciated by those skilled in the art that various modifications of the present invention may be devised without departing from the essential concept of the invention, and all such modifications are intended to be included in the scope of the claims appended hereto.

In this patent document, the word “comprising” is used in its non-limiting sense to mean that items following that word are included, but items not specifically mentioned are not excluded. A reference to an element by the indefinite article “a” does not exclude the possibility that more than one of the element is present, unless the context clearly requires that there be one and only one such element.

What is claimed is:

1. A drip tray apparatus comprising:
(a) a tray having a bottom plate and a plurality of walls extending upward from the bottom plate so as to define a chamber having an open top; and
(b) a cover having a top plate with an upper surface and a lower surface, said cover being adapted to engage the upper edges of the walls so as to create a substantially liquid-tight seal between the cover and the walls when the cover is in a closed position on the tray.

2. The drip tray apparatus of claim 1 wherein:
(a) the upper edges of the tray walls are configured to define a continuous primary shoulder and a continuous curb;
(b) continuous primary resilient sealing means is positioned on the primary shoulder;
(c) the cover is configured to define a continuous, downwardly-extending primary lip, said primary lip being matingly engageable with the primary sealing means;
such that when the cover is placed over the tray with the primary lip aligned with the primary sealing means, application of downward force on the cover will urge the primary lip into mating and substantially liquid-tight engagement with the primary sealing means.

3. The drip tray apparatus of claim 2 wherein the primary shoulder is contiguous with the outer surfaces of the tray walls.

4. The drip tray apparatus of claim 2 wherein the primary shoulder is contiguous with the inner surfaces of the tray walls.

5. The drip tray apparatus of claim 2 wherein the primary shoulder is located at the bottom of a continuous groove substantially centrally disposed within the thickness of the walls.

6. The drip tray apparatus of claim 2 wherein the primary shoulder is contiguous with the inner surfaces of the tray walls.

7. The drip tray apparatus of claim 1 wherein the cover is removable from the tray.

8. The drip tray apparatus of claim 1 wherein the cover is hingingly attached to one wall of the tray.

9. The drip tray apparatus of claim 1, further comprising latching means for releasably securing the cover to the tray when the cover is in the closed position.

10. The drip tray apparatus of claim 9 wherein the latching means comprises a plurality of latching devices each having a first component and a second component:
(a) with the first components being mounted to the tray in selected locations near the upper edges of the walls; and
(b) with the second components being mounted to the cover such that each second component is lockingly engageable with a corresponding first component when the cover is placed on the tray.

11. The drip tray apparatus of claim 10 wherein the components of the latching devices are mounted to the tray and cover so as to require application of a downward force to the cover to urge each set of first and second components into locking engagement, such that when the cover is in the closed position with the latching devices engaged, the primary lip of the cover presses into the primary sealing means.

12. The drip tray apparatus of claim 1 wherein the primary sealing means comprises rubber.

13. The drip tray apparatus of claim 1 wherein the primary sealing means comprises a foam material.

14. The drip tray apparatus of claim 2, further comprising secondary resilient sealing means disposed between the top of the curb and the lower surface of the top plate of the cover, such that application of downward force on the cover will compress the secondary resilient sealing means between the cover and the curb.

15. The drip tray apparatus of claim 1, further comprising a plurality of lifting handles mounted to the tray.

16. The drip tray apparatus of claim 1 wherein the tray has an outlet for draining liquid from the tray chamber.

17. The drip tray apparatus of claim 1 wherein the tray is made from a material comprising plastic.

18. The drip tray apparatus of claim 1 wherein the cover is made from a material comprising plastic.

19. The drip tray apparatus of claim 1 wherein the cover has an outlet for draining liquid from the tray chamber.
